(19) United States
(12) Patent Application Publication
(10) Pub. No.: US 2017/0234471 A1
(43) Pub. Date: Aug. 17, 2017

(54) Duct System with Multiple Flex Duct Sections

(71) Applicant: Robert Daniel Oberlander, Frederick, MD (US)

(72) Inventor: Robert Daniel Oberlander, Frederick, MD (US)

(21) Appl. No.: 15/436,483

(22) Filed: Feb. 17, 2017

Related U.S. Application Data
(60) Provisional application No. 62/296,393, filed on Feb. 17, 2016.

(51) Int. Cl. F16L 51/03; F16L 23/00; F16L 33/02; F16L 55/09; F16L 59/153

(52) U.S. Cl. CPC F16L 51/03; F16L 55/09; F16L 59/153; F16L 33/02; F16L 23/00

(57) ABSTRACT

A duct system with multiple flex duct sections includes a duct take off, a duct register boot, at least one flexible duct assembly that includes an inlet coupler, an outlet coupler, and a duct section. The inlet coupler and outlet coupler are terminally connected to the duct section completing the flexible duct assembly as the number of duct assemblies determines the length of the duct system. The duct takeoff is mounted to the inlet coupler, and the duct register boot is mounted to the outlet coupler as the duct takeoff is in fluid communication with the duct register boot through the flexible duct assembly. Additionally, an air controlling device can be mounted with respect to three different places, wherein the three different places are in between two couplers, the coupler and the duct takeoff, and the duct register boot and the coupler to improve the efficiency of the duct system.

The current application claims a priority to the U.S. Provisional Patent application Ser. No. 62/296,393 filed on Feb. 17, 2016.

### FIELD OF THE INVENTION

The present invention relates generally to a duct system with multiple flex duct sections. More specifically, the present invention is a system of mounting multiple flex duct sections from the duct takeoff to the duct register boot, with a plurality of fasteners.

### BACKGROUND OF THE INVENTION

Flexible ducts are typically made of flexible plastic over a metal wire coil and configured to have a tubular shape body. The flexible ducts are convenient for use in multiple applications including heating and air conditioning systems and air discharging purposes as they can quickly and easily connect with the respective devices compare to standard sheet metal fittings. The flexible ducts can also include an insulation layer, preferably made of glass wool, polyester, or polyethylene, to improve thermal insulation. However, there are some limitations and problems with flexible ducts as the flexible ducts extend as a continuous run from the duct takeoff to the duct register boot. For example, flexible ducts are sometimes incorrectly installed with sharp turns and squeezed through tight spaces in order to reduce labor cost and material cost. As a result, the flexible ducts fail to maintain a constant air flow within the system as the sharp turns and tight spaces constrict the air flow. Another example, the flexible ducts are intentionally installed as long runs to minimize turns and to reduce noise from the air handler. This causes the flexible ducts to sang and losses structural integrity over time. Another example, the flexible ducts are not pulled tight or properly installed resulting resistance to air flow and pressure loss.

It is an objective of the present invention to provide a duct system with multiple flex duct sections. More specifically, the present invention combines multiple pre-determined length duct sections into a continuous run through a plurality of couplers. The duct sections and the plurality of couplers are mounted to each other by a plurality of fasteners. Each of the plurality of couplers can be electrically powered with an external power supply so that the present invention allows other air controlling devices, such as air circulators, air amplifiers, and air purifiers, to be integrated into the plurality of couplers. Resultantly, the duct sections, the plurality of couplers, the plurality of fasteners, and the air controlling device completes the present invention to improve the structural integrity of the system and the efficiency of the flexible duct system.

### BRIEF DESCRIPTION OF THE DRAWINGS

FIG. 1 is a perspective view of the first embodiment of the present invention.

FIG. 2 is a side view of the first embodiment of the present invention.

FIG. 3 is a cross sectional view of the present invention, wherein the cross-sectional view is taken upon the length of the of the present invention showing the uninsulated flex ducts sections.

FIG. 4 is a cross sectional view of the present invention, wherein the cross-sectional view is taken upon the length of the of the present invention showing the insulated flex ducts sections.

FIG. 5 is a side view of the duct takeoff of the present invention.

FIG. 6 is a side view of the duct register boot of the present invention.

FIG. 7 is a side view of the inlet coupler of the present invention, wherein the outlet coupler is configured to be similar as the inlet coupler.

FIG. 8 is a schematic showing the electrical connections within the coupler housing for the inlet coupler or the outlet coupler.

FIG. 9 is a side view of the first configuration for the second embodiment of the present invention.

FIG. 10 is a side view of the second configuration for the second embodiment of the present invention.

FIG. 11 is a side view of the third configuration for the second embodiment of the present invention.

### DETAIL DESCRIPTIONS OF THE INVENTION

All illustrations of the drawings are for the purpose of describing selected versions of the present invention and are not intended to limit the scope of the present invention.

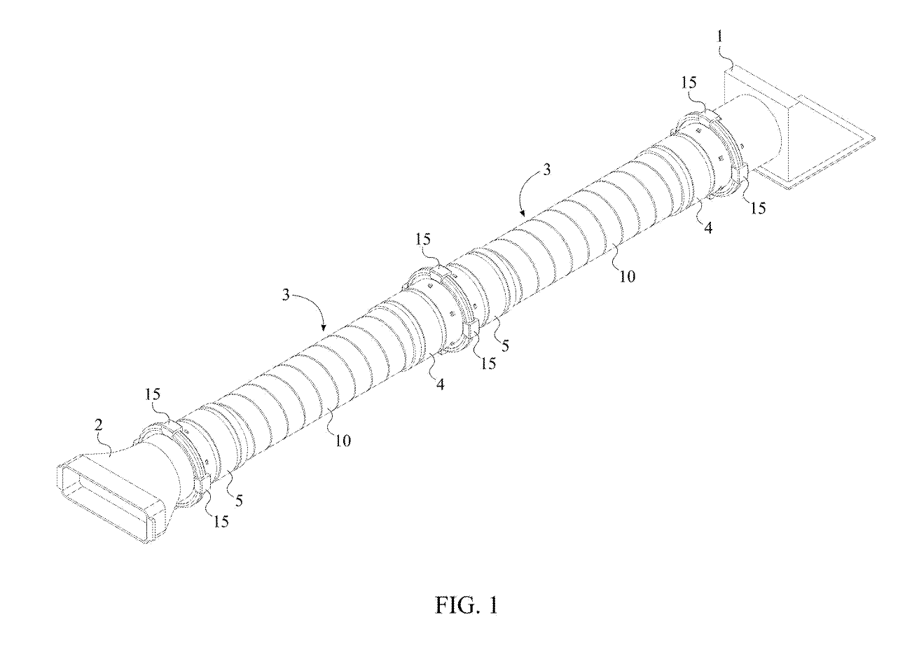

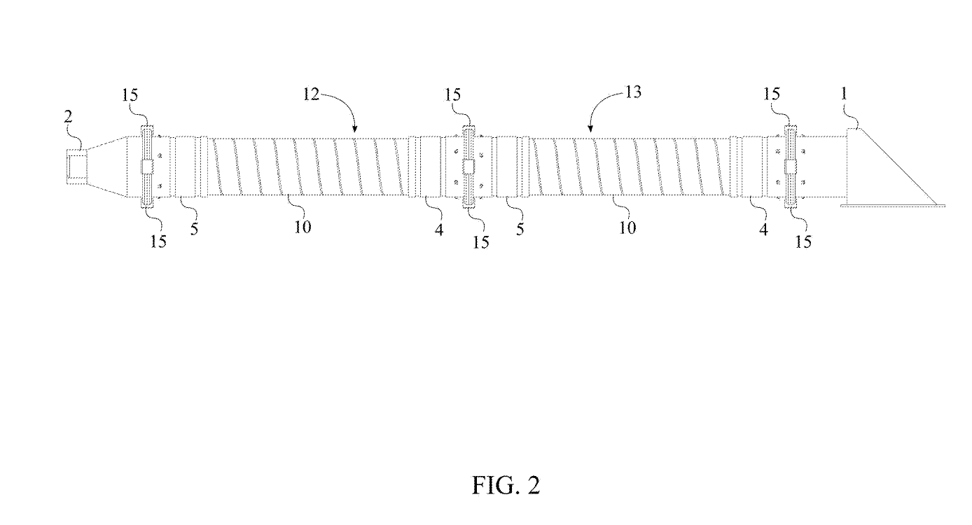

The present invention is a duct system with multiple flex duct sections so that the present invention is able to improve problems and limitations of conventional flexible duct systems. Even though the conventional flexible duct system can be easily installed compare to standard sheet metal duct system, the conventional flexible duct system tends to have resistance to air flow and pressure loss about sharp turns, tightly squeezed spaces, and improper installations. Additionally, the conventional flexible duct system also sags and losses their structural integrity when the conventional flexible ducts are installed over an extended distance. In reference to FIG. 1-2, the present invention comprises a duct takeoff 1, a duct register boot 2, and at least one flexible duct assembly 3. The at least one flexible duct assembly 3 comprises an inlet coupler 4, an outlet coupler 5, and a duct section 10. More specifically, the inlet coupler 4 and the outlet coupler 5 are oppositely positioned of each other along the duct section 10 to complete the general arrangement of the at least one flexible duct assembly 3. The inlet coupler 4 and the outlet coupler 5 are concentrically and terminally connected to the duct section 10, wherein the inlet coupler 4 and the outlet coupler 5 provide a rigid mounting platform for adjacent at least one flexible duct assembly 3, the duct takeoff 1, and/or the duct register boot 2. In other words, the duct takeoff 1 is mounted to the inlet coupler 4 while the duct register boot 2 is mounted to the outlet coupler 5. In order to provide laminar air flow within the present invention, the duct takeoff 1 is in fluid communication with the duct register boot 2 with the at least one flexible duct assembly 3.

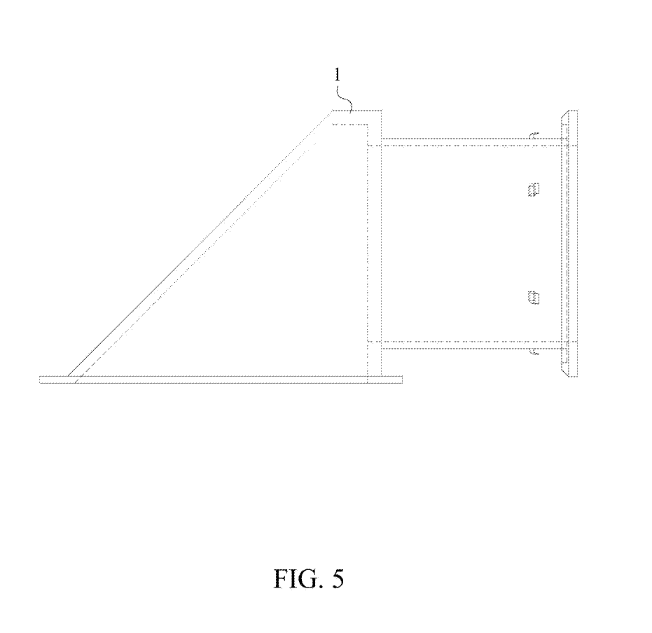

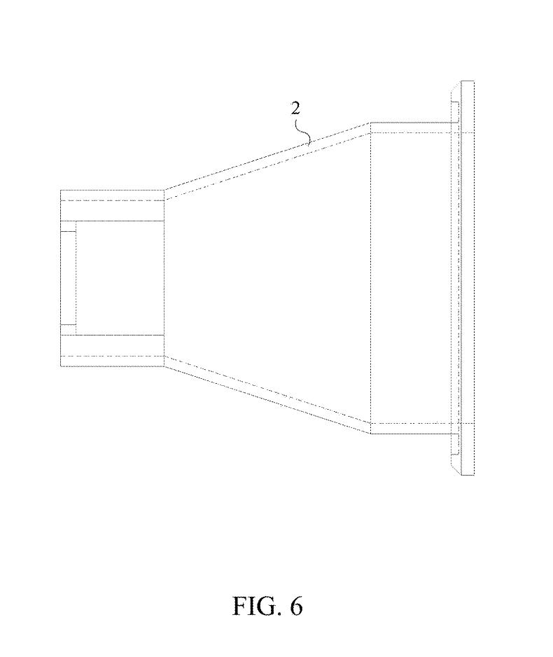

The duct takeoff 1 and the duct register boot 2 of the present invention functions similar to conventional takeoff and register boot. However, an outlet of the duct takeoff 1 and an inlet of the duct register boot 2 each comprise a flange as shown in FIG. 5-6. The flange is encircled around the outlet of the duct takeoff 1 and the inlet of the duct register boot 2, wherein the flange is utilized to secure the at least one flexible duct assembly 3.

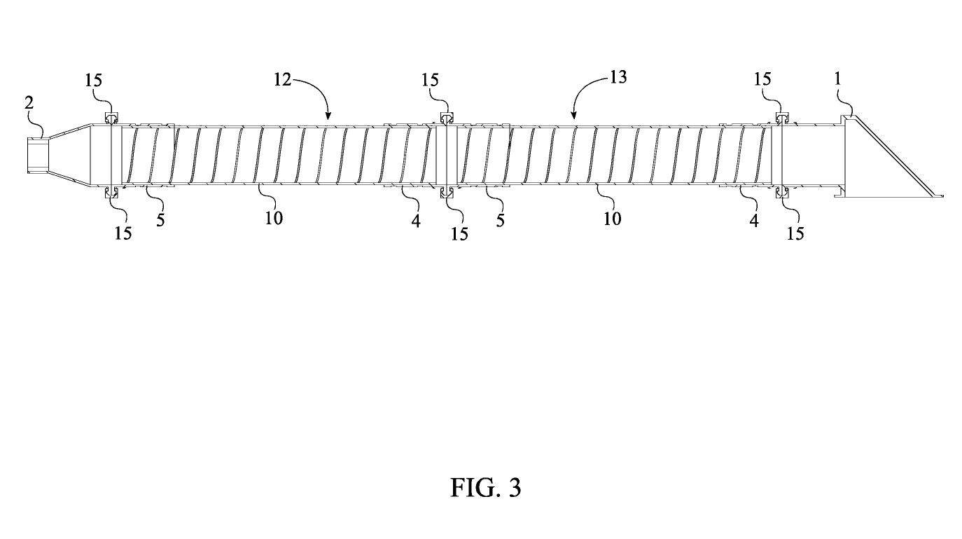

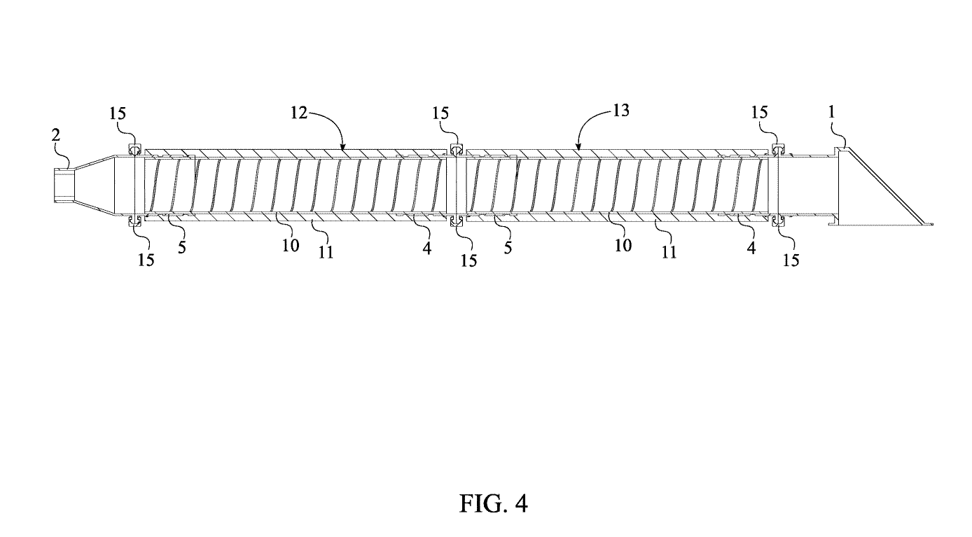

In reference to FIG. 3 and FIG. 4, the present invention can use insulated flex ducts and uninsulated flex ducts as the duct section 10. When the duct section 10 is an uninsulated flex duct, the duct section 10 circumferentially traverses into the inlet coupler 4 and the outlet coupler 5 as the duct section 10 is internally connected to the inlet coupler 4 and the outlet coupler 5. More specifically, the internal connection between the duct section 10 and the inlet coupler 4 or the outlet coupler 5 can utilize any types of fastening mechanism know to industry standard as long as the fastening mechanism does not hinder the laminar air flow and the structural integrity of the duct section 10. When the duct section 10 is an insulated flex duct, the duct section 10 is encircled by an insulation sleeve 11. The duct section 10 circumferentially traverses into the inlet coupler 4 and the outlet coupler 5 as the duct section 10 is internally connected to the inlet coupler 4 and the outlet coupler 5. More specifically, the internal connection between the duct section 10 and the inlet coupler 4 or the outlet coupler 5 can utilize any types of fastening mechanism know to industry standard as long as the fastening mechanism does not hinder the laminar air flow and the structural integrity of the duct section 10. The insulation sleeve 11 is circumferentially positioned around the inlet coupler 4 and the outlet coupler 5 as the insulation sleeve 11 is externally connected to the inlet coupler 4 and the outlet coupler 5. More specifically, a plurality of retain hooks that is radially positioned around the inlet coupler 4 and the outlet coupler 5 allows the insulation sleeve 11 to be externally stretched and secured around the inlet coupler 4 and the outlet coupler 5.

The duct section 10 is limited to a pre-determined length, preferably 5-foot section, so that the inlet coupler 4 and the outlet coupler 5 are able to optimize the lamina air flow within the flexible duct assembly 3. However, duct section 10 can be configured to any other desired length sections other than the 5-foot sections to accommodate any system requirements.

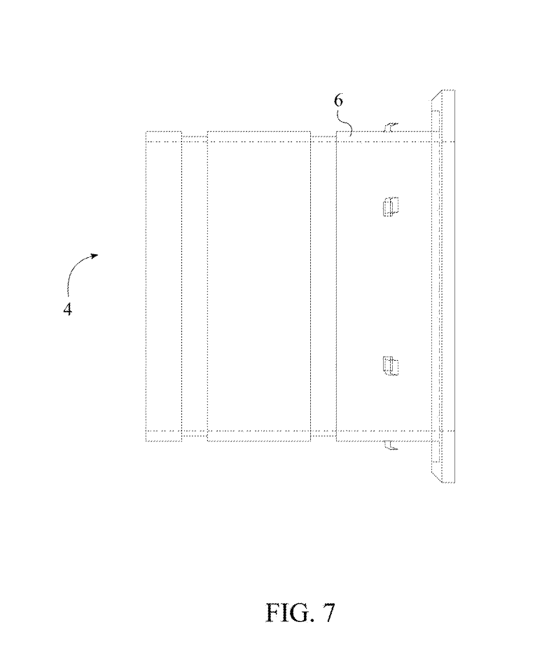

The inlet coupler 4 and the outlet coupler 5 each comprise a coupler housing 6 and a coupler flange as shown in FIG. 7. The coupler flange for the inlet coupler 4 is parametrically and terminally connected around the coupler housing 6 for the inlet coupler 4 and positioned opposite of the duct section 10. The coupler flange for the outlet coupler 5 is parametrically and terminally connected around the coupler housing 6 for the outlet coupler 5 and positioned opposite of the duct section 10. As a result, the coupler flange for the inlet coupler 4 and the outlet coupler 5 are able to provide an attachment platform so that the at least one flexible duct assembly 3 can be mounted to the duct takeoff 1 and the duct register boot 2 with a plurality of fasteners 15.

A first embodiment of the present invention, which is the basic embodiment, is shown in FIG. 2. In order to mount the duct takeoff 1 to the inlet coupler 4 and the duct register boot 2 to the outlet coupler 5, the first embodiment utilizes the plurality of fasteners 15 as each of the plurality of fasteners 15 is preferably formed into a rigid clip. More specifically, the plurality of fasteners 15 is equally distributed around the at least one flexible duct assembly 3 and mounts the flange of the duct takeoff 1 to the coupler flange of the inlet coupler 4. Similarly, the plurality of fasteners 15 mounts the flange of the duct register boot 2 to the coupler flange of the outlet coupler 5. Resultantly, the duct takeoff 1 is in fluid communication with the duct register boot 2 with the at least one flexible duct assembly 3 as the plurality of fasteners 15 secures the at least one flexible duct assembly 3 to the duct takeoff 1 and the duct register boot 2.

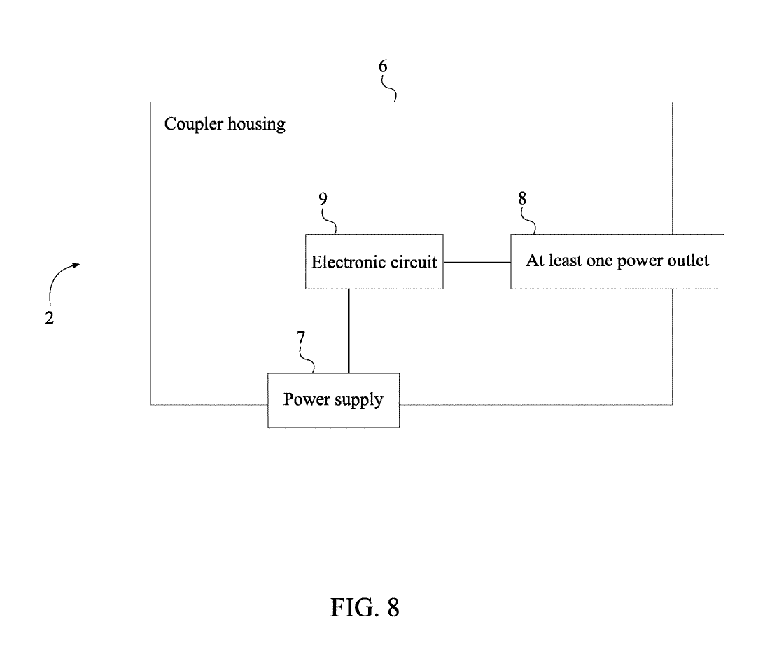

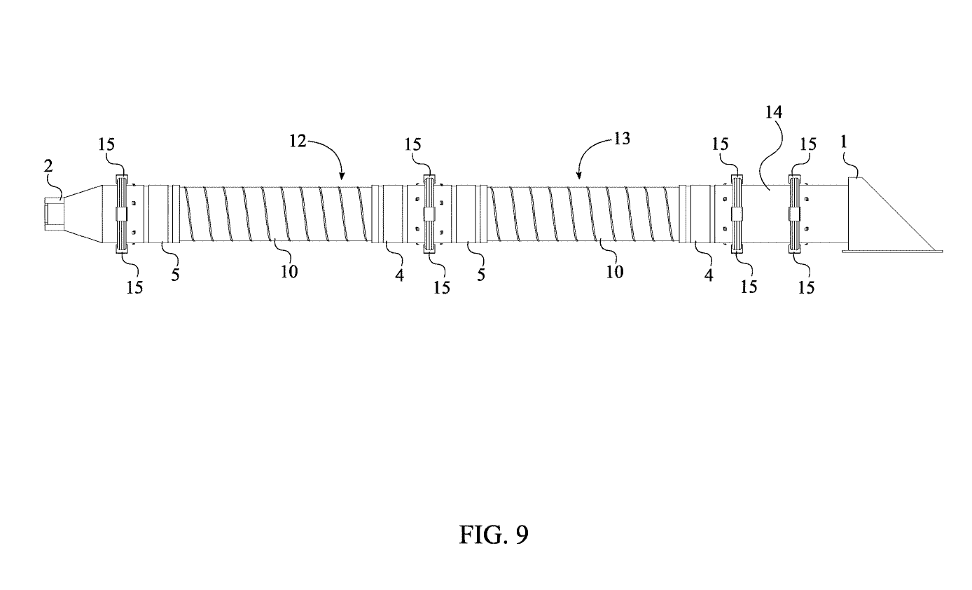

A second embodiment of the present invention that utilizes an air controlling device 14 is shown in FIG. 9-FIG. 11 as the second embodiment can have multiple configurations. The air controlling device 14 that optimizes the performance of the present invention can include, but is not limited to, an air circulator, an air amplifier, an air purifier, an ultraviolet (UV) mold purifier, a volume control damper, a zone control damper, a carbon monoxide alarm, an air multiplier, a noise canceling air register, an infrared heater, and a smoke alarm. In order to incorporate the air controlling device 14, the inlet coupler 4 and the outlet coupler 5 each further comprise a power supply 7, at least one power outlet 8, and an electronic circuit 9 in addition to the coupler housing 6 and the coupler flange as shown in FIG. 8. More specifically, the power supply 7, the at least one power outlet 8, and the electronic circuit 9 are integrated into the coupler housing 6 such that the power supply 7 is electrically connected with the at least one power outlet 8 through the electronic circuit 9. As a result, when the power supply 7 powers the electronic circuit 9 from an external power source, the electronic circuit 9 is able to power the at least one power outlet 8 that is designed to power the air controlling device 14.

In reference to FIG. 9, which illustrates a first configuration of the second embodiment, the air controlling device 14 is removably mounted to the duct takeoff 1 and the inlet coupler 4 by the plurality of fasteners 15. The duct takeoff 1 is in fluid communication with the inlet coupler 4 through the air controlling device 14 to maintain the laminar air flow within the first configuration. More specifically, the air controlling device 14 delineates a similar shape to the inlet coupler 4 and comprises a pair of connector flanges that is terminally positioned to the main body of the air controlling device 14. As a result, the plurality of fasteners 15 can be utilized to mount the pair of connector flanges to the flange of the duct takeoff 1 and the coupler flange of the inlet coupler 4. The air controlling device 14 is electrically connected to the at least one power outlet 8 of the inlet coupler 4 so that the inlet coupler 4 is able to power the air controlling device 14 within the present invention. Since the air controlling device 14 is positioned adjacent to the duct takeoff 1 within the first configuration, the compatible air controlling device 14 can be either the air circulator, the air amplifier, the air purifier, the UV mold purifier, the volume control damper, the zone control damper, the carbon monoxide alarm, or the smoke alarm.

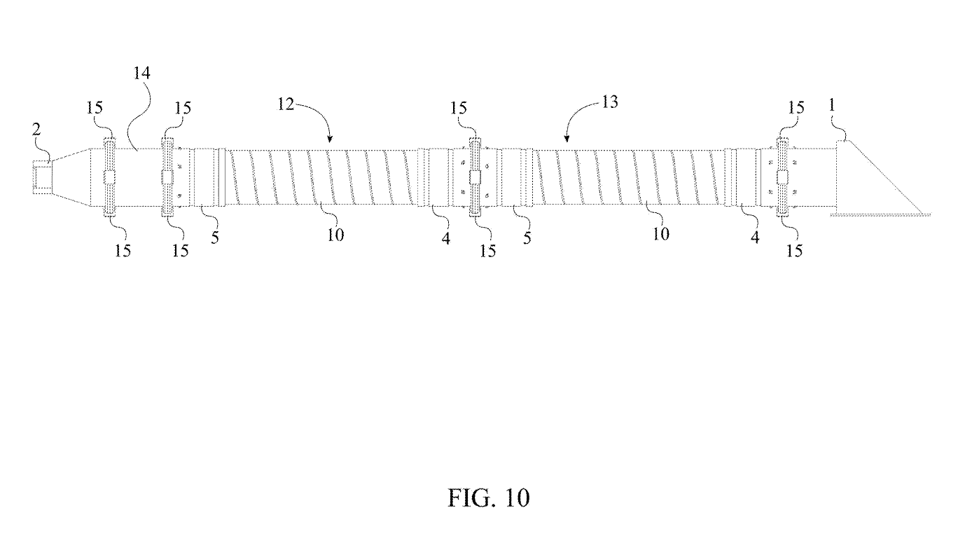

In reference to FIG. 10, which illustrates a second configuration of the second embodiment, the air controlling device 14 is removably mounted to the duct register boot 2 and the outlet coupler 5 by the plurality of fasteners 15. The duct register boot 2 is in fluid communication with the outlet coupler 5 through the air controlling device 14 to maintain the laminar air flow within the second configuration. More specifically, the air controlling device 14 delineates a similar shape to the outlet coupler 5 and comprises the pair of connector flanges that is terminally positioned to the main body of the air controlling device 14. As a result, the plurality of fasteners 15 can be utilized to mount the pair of connector flanges to the flange of the duct register boot 2 and the coupler flange of the outlet coupler 5. The air controlling device 14 is electrically connected to the at least one power outlet 8 of the outlet coupler 5 so that the outlet coupler 5 is able to power the air controlling device 14 within the present invention. Since the air controlling device 14 is positioned adjacent to the duct register boot 2 within the second configuration, the compatible air controlling device 14 can be either the air circulator, the air amplifier, the air purifier, the UV mold purifier, the carbon monoxide alarm, the air multiplier, the noise canceling air register, the infrared heater, or the smoke alarm.

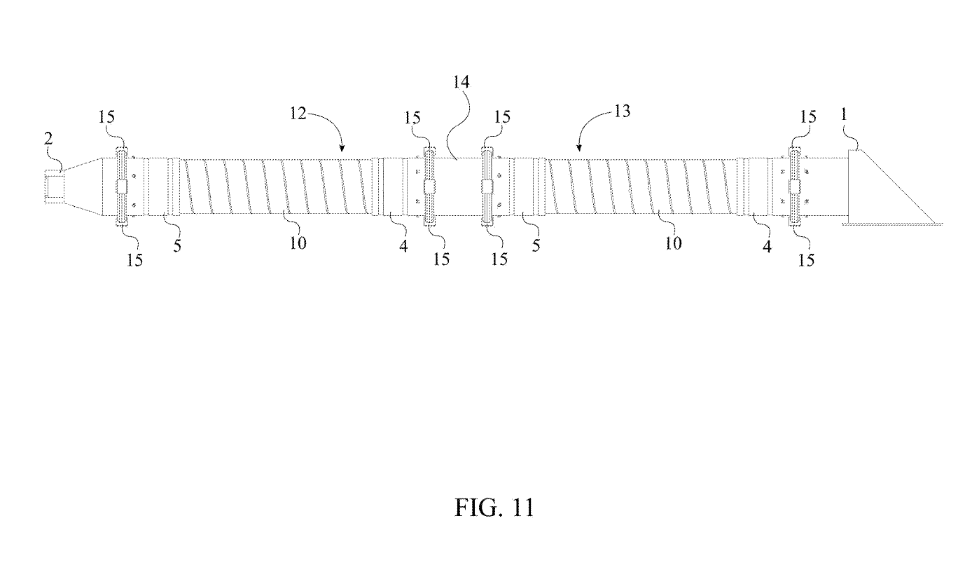

In reference to FIG. 11, which illustrates a third configuration of the second embodiment, the at least one flexible duct assembly 3 comprises a first duct assembly 12 and a second duct assembly 13. The duct takeoff 1 is mounted to the inlet coupler 4 of the first duct assembly 12 by the plurality of fasteners 15 while the air controlling device 14 is removably mounted to the outlet coupler 5 of the first duct assembly 12 and the inlet coupler 4 of the second duct assembly 13 by the plurality of fasteners 15. The duct register boot 2 is then mounted to the outlet coupler 5 of the second duct assembly 13 by the plurality of fasteners 15. The duct takeoff 1 is in fluid communication with the duct register boot 2 through the first duct assembly 12, the air controlling device 14, and the second duct assembly 13 to maintain the laminar air flow within the third configuration. More specifically, the air controlling device 14 delineates a similar shape to the inlet coupler 4 and the outlet coupler 5 and comprises the pair of connector flanges that is terminally positioned to the main body of the air controlling device 14. As a result, the plurality of fasteners 15 can be utilized to mount the pair of connector flanges to the coupler flange of the outlet coupler 5 and the coupler flange of the inlet coupler 4. The air controlling device 14 is electrically connected to the at least one power outlet 8 of the outlet coupler 5 or the inlet coupler 4 so that the respective coupler is able to power the air controlling device 14 within the present invention. Since the air controlling device 14 is positioned in between the first duct assembly 12 and the second duct assembly 13 within the third configuration, the compatible air controlling device 14 can be either the air circulator, the air amplifier, the carbon monoxide alarm, or the smoke alarm.

Even though the second embodiment of the present invention is explained in relation to three different configurations, the second embodiment can have any combination of the first configuration, the second configuration, and the third configuration to optimize the efficiency of the present invention or to accommodate consumer requirements.

Additionally, a personal computing device can remotely control the air controlling device 14 through a wireless network and a control panel. More specifically, the control panel is mounted adjacent the present invention so that the personal computing device is able to communicably coupled with the air controlling device 14 through the wireless network and the control panel. As a result, the present invention can seamlessly integrate a voice-controlled intelligent personal assistance device to control the air controlling device 14 upon user's preference.

The duct takeoff 1, the duct register boot 2, the inlet coupler 4, and the outlet coupler 5 are preferably made from heat resistance plastic. Additionally, the plurality of fasteners 15 are made from heat resistance plastic, wherein the heat resistance plastic eliminates leaky seems, eliminates leaky connections, and to drastically reduces heat loss and coolness loss.

Although the invention has been explained in relation to its preferred embodiment, it is to be understood that many other possible modifications and variations can be made without departing from the spirit and scope of the invention as hereinafter claimed.

What is claimed is:

1. A duct system with multiple flex duct sections comprises:
a duct takeoff;
a duct register boot;
at least one flexible duct assembly;
the at least one flexible duct assembly comprises an inlet coupler, an outlet coupler, and a duct section;
the inlet coupler and the outlet coupler being oppositely positioned of each other along the duct section;
the inlet coupler and the outlet coupler being concentrically connected to the duct section;
the duct takeoff being mounted to the inlet coupler a plurality of fasteners;
the duct register boot being mounted to the outlet coupler a plurality of fasteners; and
the duct takeoff being in fluid communication with the duct register boot with the at least one flexible duct assembly.

2. The duct system with multiple flex duct sections as claimed in claim 1 comprises:
the duct section being circumferentially traverses into the inlet coupler and the outlet coupler; and
the duct section being internally connected to the inlet coupler and the outlet coupler.

3. The duct system with multiple flex duct sections as claimed in claim 1 comprises:
an insulation sleeve;
the duct section being encircled by the insulation sleeve;
the duct section circumferentially traverses into the inlet coupler and the outlet coupler;
the duct section being internally connected to the inlet coupler and the outlet coupler;
the insulation sleeve being circumferentially positioned around the inlet coupler and the outlet coupler; and
the insulation sleeve being externally connected to the inlet coupler and the outlet coupler.

4. The duct system with multiple flex duct sections as claimed in claim 1, wherein the duct section is a pre-determined length.

5. The duct system with multiple flex duct sections as claimed in claim 1 comprises:
an air controlling device;
the inlet coupler and the outlet coupler each comprises a coupler housing, a power supply, at least one power outlet, and an electronic circuit;
the power supply, the at least one power outlet, and the electronic circuit being integrated into the coupler housing; and
the power supply being electrically connected to the at least one power outlet through the electronic circuit.

6. The duct system with multiple flex duct sections as claimed in claim 5 comprises:
the air controlling device being removably mounted to the duct takeoff and the inlet coupler by the plurality of fasteners;
the duct takeoff being in fluid communication with the inlet coupler through the air controlling device; and
the air controlling device being electrically connected to the at least one power outlet of the inlet coupler.

7. The duct system with multiple flex duct sections as claimed in claim 6 comprises:
the air controlling device comprises a device selected from a group consisting of an air circulator, an air amplifier, an air purifier, an ultraviolet mold purifier, a volume control damper, a zone control damper, a carbon monoxide alarm, and a smoke alarm.

8. The duct system with multiple flex duct sections as claimed in claim 5 comprises:
the air controlling device being removably mounted to the duct register boot and the outlet coupler by a plurality of fasteners;
the duct register boot being in fluid communication with the outlet coupler through the air controlling device; and
the air controlling device being electrically connected to the at least one power outlet of the outlet coupler.

9. The duct system with multiple flex duct sections as claimed in claim 8 comprises:
the air controlling device comprises a device selected from a group consisting of an air circulator, an air amplifier, an air purifier, an ultraviolet (uv) mold purifier, a carbon monoxide alarm, an air multiplier, a noise canceling air register, an infrared heater, and a smoke alarm.

10. The duct system with multiple flex duct sections as claimed in claim 5 comprises:
the at least one flexible duct assembly comprises a first duct assembly and a second duct assembly;
the duct takeoff being mounted to the inlet coupler of the first duct assembly;
the air controlling device being removably mounted to the outlet coupler of the first duct assembly and the inlet coupler of the second duct assembly by the plurality of fasteners;
the duct register boot being mounted to the outlet coupler of the second duct assembly;
the duct takeoff being in fluid communication with the duct register boot with the first duct assembly, the air controlling device, and the second duct assembly; and
the air controlling device being electrically connected to the at least one power outlet of the outlet coupler or the inlet coupler.

11. The duct system with multiple flex duct sections as claimed in claim 10 comprises:
the air controlling device comprises a device selected from a group consisting of an air circulator, an air amplifier, a carbon monoxide alarm, and a smoke alarm.

12. The duct system with multiple flex duct sections as claimed in claim 1, wherein the plurality of fasteners is made from heat resistance plastic.
